(19) United States
(12) Patent Application Publication
(10) Pub. No.: US 2003/0029309 A1
(43) Pub. Date: Feb. 13, 2003

(54) Fluid-actuated linear drive

(76) Inventors: Bernd Beuth, Goppingen (DE); Andreas Muth, Kirchheim (DE); Stefan-Johannes Demuth, Benningen (DE)

Correspondence Address: HOFFMANN & BARON, LLP, 6900 JERICHO TURNPIKE, SYOSSET, NY, 11791, US

(21) Appl. No.: 10/221,539

(22) PCT Filed: Mar. 9, 2001
(86) PCT No.: PCT/EP01/02660

(30) Foreign Application Priority Data
Mar. 17, 2000 (DE) 200 04 076.3

(51) Int. Cl. F15B 13/044

(52) U.S. Cl. 91/459

(57) ABSTRACT

A fluid power operate linear drive possessing a slab housing (2) with an elongated cross sectional outline, in which a plurality of receiving spaces (8) are arranged extending in a common housing plane adjacent to each other in the direction of the longitudinal axis (3) of the cross section. At one first narrow side (21) of the housing there is a piston receiving space (12) extending in the longitudinal direction containing a piston (13) connected with an outwardly running force output part (16). At the opposite second narrow housing side (22) there is an electronic circuitry receiving space (23) containing electronic valve control circuitry (24). Between the piston receiving space (12) and the electronic circuitry receiving space (23) there is at least one valve receiving space (26), which contains a control valve means (25), which is able to be electrically operated and serves for the control of fluid actuation of the piston (13).

The invention relates to a fluid power linear drive whose housing contains a piston able to be displaced by fluid actuation and furthermore an electrically activated control valve means for the control of the fluid actuation.

A linear drive disclosed in the European patent publication 0 713 980 A2 of this type comprises a central piston receiving space extending in the longitudinal direction and in which a piston is arranged which is connected with a piston rod. For the operation of the piston pressure medium may be admitted in a controlled fashion, for which purpose a control valve means is present, which includes several control valves inserted like cartridges into the covering lid of the housing of the linear drive. The activation of the control valves takes place by the intermediary of electronic valve control circuitry, which is also secured in the housing.

This known linear drive does admittedly possess a high degree of integration of the functionally relevant components, but however is less suitable as a basis for the design of miniaturized structures. Accordingly one object of the present invention is to provide a linear drive, on the basis of which more compact sizes are possible while maintaining an integrated design.

This object is to be attained by a fluid power linear drive comprising a slab-like housing with an elongated cross sectional outline, in which slab housing a plurality of receiving spaces are located placed in a common housing plane adjacent to each other in the direction of the cross section's longitudinal axis, a piston receiving space being provided at a first one of the two narrow sides of the housing, such piston receiving space extending in the longitudinal direction and containing a piston connected with an outwardly extending force output part while at the opposite second narrow housing side an electronic circuitry receiving space is provided, which contains electronic valve control circuitry, and between the piston receiving space and the electronic circuitry receiving space at least one valve receiving space for electrically operated control valve means is located, such control valve means serving for the control of the fluid actuation of the piston.

The linear drive accordingly possesses a housing, which may be designed to be extremely flat and is therefore termed a slab housing, wherein receiving spaces for the functionally relevant components are arranged longitudinally adjacent to each other in such a manner that they lie in a common plane coinciding with the cross sectional longitudinal axis of the slab housing, and the available volume of the slab housing is optimally employed. The piston receiving space is associated with one of the narrow sides of the housing with the result that on three sides there is a relatively small wall thickness, which if necessary renders possible reliable sensor detection of the piston position. The opposite narrow side of the housing is associated with a receiving space for electronic circuitry, such space containing the electronic valve control circuitry, which can generate the switching signals necessary for the actuation of the control valve means. The control valve means is seated, as considered in the direction of the longitudinal axis of the cross section of the slab housing, between the piston receiving space and the electronic circuitry receiving space so that on the one hand there are shorter signal paths to the electronic valve control circuitry and on the other hand there are shorter fluid paths to the piston receiving space. The linear drive together with its various components may be extremely simply installed, the overall structure being sturdy in conjunction with an extremely compact form, such overall structure being suitable for miniaturized applications.

Further advantageous developments of the invention are defined in the dependent claims.

The electronic valve control circuitry is preferably provided on a pcb-like (i. e. like a printed circuit board) electronic circuitry support, which is more particularly so inserted in the electronic circuitry receiving space that its board plane is at a right angle to the longitudinal axis of the cross section of the slab housing with the result that compact dimensions are adhered to in the longitudinal direction of the cross section.

In order to be able to link the electronic valve control circuitry with the control valve means in an optimum manner electrically, it is preferred to provide a uniform control receiving space divided up into sections, which on the one hand represent the valve receiving space and on the other hand the electronic circuitry receiving space.

On the longitudinal side, which is opposite to the valve receiving space, of the piston receiving space a sensor means receiving space may be provided, which contains a position detecting means for the detection of the piston position. This means preferably comprises one or more sensors able to be set in a variable manner in the longitudinal direction of the sensor means receiving space, such sensors being electrically connected with the electronic valve control circuitry. It is more especially advantageous for the position detecting means to possess a printed circuit board extending in the longitudinal direction of the sensor means receiving space, such board serving for the transmission of position signals from and/or to the sensors, which may be arranged on the printed circuit board in a manner allowing longitudinal adjustment.

Instead of a control valve means having a 5/2 switching function, which would also be possible, a design is to be particularly recommended with two separate control valve units, which respectively possess a 3/2 switching function and which are respectively responsible for the supply of fluid to the piston for driving same in one of the two possible directions of motion thereof. These two control valve units are preferably accommodated in the longitudinal direction of the slab housing one after the other in a common valve receiving space, it being possible to have a provision such that at least the valve drive signals for one control valve unit are also transmitted by way of the position detecting means so that same may assume a double function as regards transmission of electrical signals.

The slab housing of the linear drive preferably comprises a principal housing body, wherein the different receiving spaces are formed extending from axial one end to the other, a design in the form of an extrusion being more especially possible. The termination of the principal housing body may be in the form of lid-like coverings, which may simultaneously also perform the holding function as regards the component valve means. Between a respective covering and the principal housing body it is possible to fit a printed circuit board, which may be employed for signal transmission between the position detecting means and the electronic valve control circuitry and/or the control valve units.

The printed circuit board may be provided with sealing means, which serve to ensure a fluid-tight connection between the covering and the principal housing body and which in case of need may at least partially perform the function of light guide means in order to render the light signals visible from the outside. The light signal may for example indicate the state of activation of the control valve means and/or the piston position.

The linear drive is more particularly suitable for being fitted with a control valve means, whose valves are at least partly constituted by microvalves produced by micromaching, the use of piezoelectric valves also being possible.

It is furthermore an advantage if both the fluid and also the electrical terminals or connections of the linear drive are collected together on a common terminal side of the slab housing, such side preferably being the rear side which is opposite to the front side with the piston rod extending through it.

In the following an account will be provided of the invention with reference to the accompanying drawings.

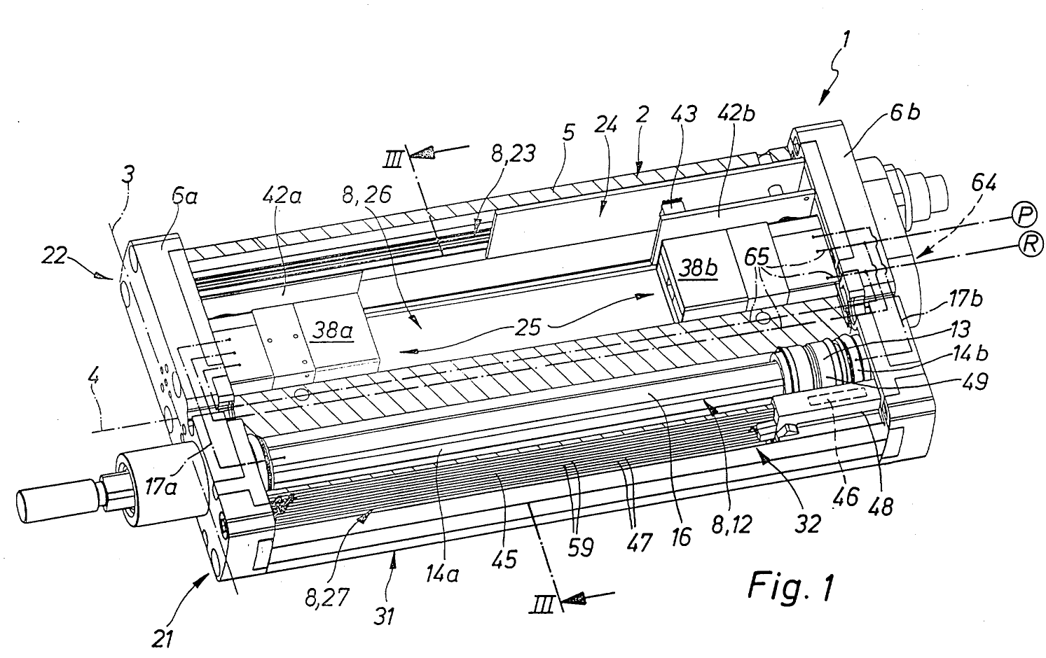

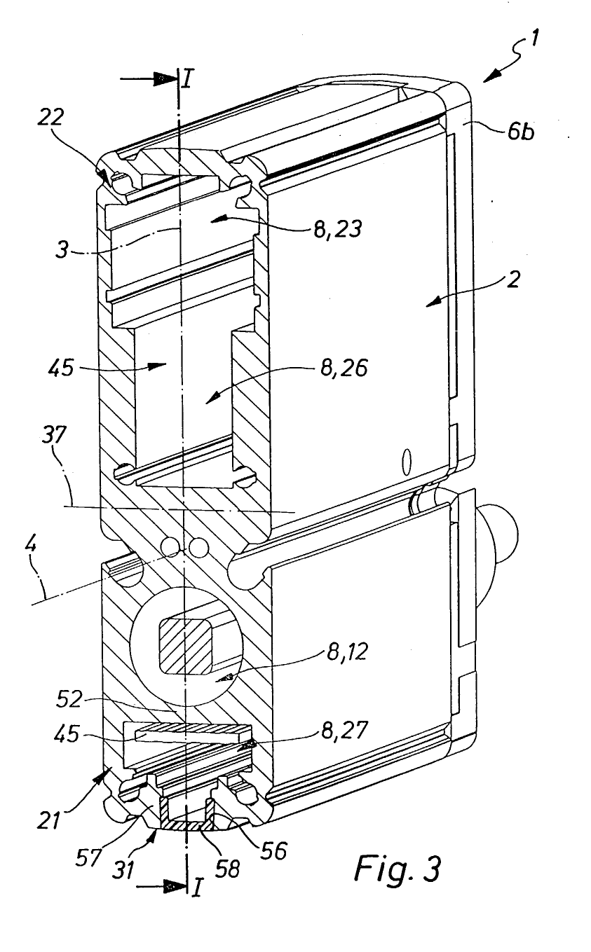

FIG. 1 shows a preferred design of the fluid power linear drive of the invention in an oblique elevation and with the slab housing partly illustrated in longitudinal section, the line of the section being indicated at I-I in FIG. 3.

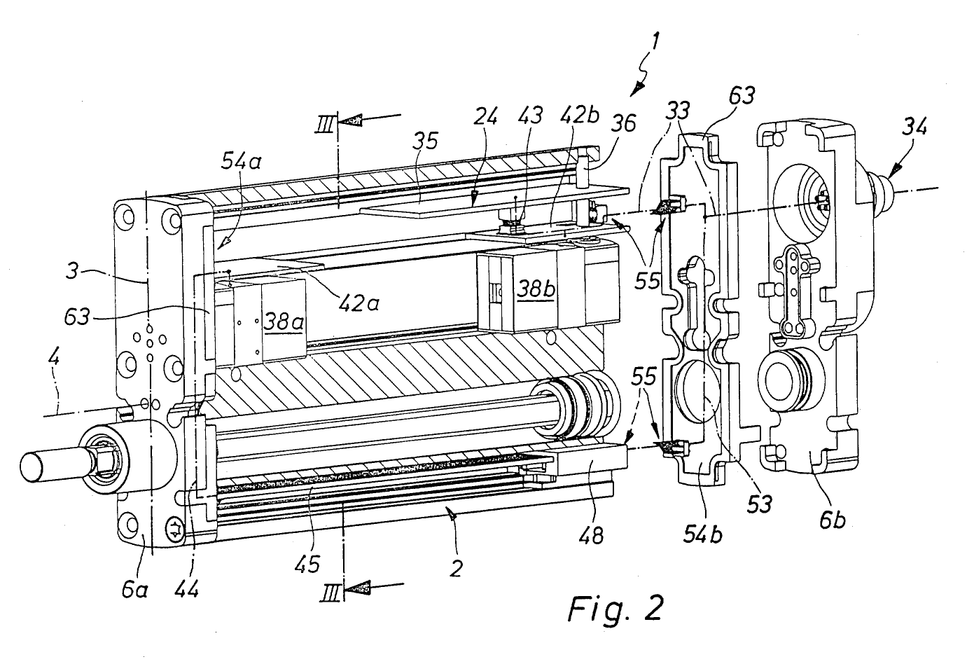

FIG. 2 shows the linear drive of FIG. 1 in a somewhat different perspective view, the covering at the rear being removed.

FIG. 3 illustrates the linear drive of FIGS. 1 and 2 in a perspective view in a cross section in accordance with the section line III-III as in FIGS. 1 and 2.

The linear drive 1 possesses an elongated housing, which owing to its flatiron shape is termed a slab housing 2. As more particularly appears from FIGS. 2 and 3, such slab housing 2 possesses an elongated cross section with a preferably rectangular outline, the longitudinal axis of the cross section being referenced 3. The latter extends at a right angle to the longitudinal axis of the slab housing 2, such longitudinal axis being referenced 4.

The slab housing 2 contains a principal housing body 5 defining the major part of the overall length and furthermore front and rear lid-like coverings 6a and 6b, mounted on the two axially aligned terminal sides thereof. All these parts have the above mentioned elongated oblong cross sectional shape.

In the interior of the slab housing 2 in the case of the present example in all four respectively receiving spaces 8 are provided, which each extend in parallelism to the longitudinal axis 3 of the housing, such receiving spaces being placed adjacent to each other and aligned in the direction of the cross sectional longitudinal axis 3 and the housing's longitudinal axis 4, same furthermore extending in a common plane of the housing. The latter axis 4 is furthermore the section plane of the representations in FIGS. 1 and 2, in which the principal housing body 5 is shown in a longitudinal section.

The receiving spaces 8 extend parallel to one another and through the principal housing body 5, in each case for the entire length thereof. It is therefore possible to design the principal housing body 5 as an aluminum extrude. The coverings 6a and 6b terminally mounted terminate the respectively associated openings of the receiving spaces 8.

Such receiving spaces 8 include-a piston receiving space 12, which contains a piston 13 adapted to be moved in the longitudinal direction thereof, such piston axially dividing up the piston receiving space 12 in a sealing manner into a front and a rear working space 14a and 14b. The piston 13 is firmly coaxially connected with a piston rod 16, which extends to the outside in a sealing fashion allowing longitudinal sliding motion through the front covering 6a and constitutes a power or force output part, at which a force or a movement is available for applications outside the system. The outer end portion of the piston rod 16 can be connected with any desired moving means.

Into each working space 14a and 14b piece there opens a first associated fluid duct 17a and 17b, through which a fluid pressure medium, and more especially compressed air, may be supplied or let off in order to drive the piston 13 and the piston rod 16 in a forwardly or rearwardly directed linear movement in parallelism to the longitudinal axis 4 of the housing.

The piston receiving space 12 is located on a narrow side 21 of the housing. The oppositely aligned second narrow side 22 of the housing is associated with a receiving space 8 designed in the form of an electronic circuitry receiving space 23 containing electronic valve control circuitry 24. By way of the latter electrical control of a control valve means 25 takes place, which is accommodated in a receiving space 8 placed between the piston receiving space 12 and the electronic circuitry receiving space 23, such receiving space 8 being herein termed the valve receiving space 26.

The fourth receiving space 8, remaining to be described, is termed a sensor means receiving space 27 and is located on the longitudinal side, opposite to the valve receiving space 26, of the piston receiving space 12 between the latter and the adjacent outer face section 31, on the narrow side, of the principal housing body 5. The sensor means receiving space 27 contains a position detecting means 32, which in the embodiment of the invention is so designed that certain predetermined axial positions of the piston 13 may be detected by it. It would also be possible to have it designed as a displacement measuring system, using which the current piston position could be found.

The electronic valve control circuitry 24 merely occupies part of the length of the electronic circuitry receiving space 23, it being accommodated in the rear end section thereof. It is connected by way of first electrical conductors 33, as indicated in chained lines, with connection or terminal means 34, which are accessible from the outside, mounted on the rear covering 6b, such connection means 34 being preferably designed in the form of plug means and rendering possible an electrical connection with an external control means, not illustrated.

Preferably the electronic valve control circuitry 24 is provided on a board-like electronic circuitry support 35, as for example as a printed circuit board, which is secured from the rear side in the electronic circuitry receiving space 23 where it is fixed by suitable securing means 36. The alignment is more particularly such that the plane of the electronic circuitry support 35 is at a right angle to the longitudinal axis 3 of the cross section or in other words the width direction of the electronic circuitry support 35 runs parallel to the transverse axis 37 of the cross section, of the slab housing 2. It is in this manner that the dimensions of the slab housing 2 along the longitudinal axis 3 coinciding with the thickness direction of the electronic circuitry support 35 are kept extremely small.

During operation the control valve means 35 receives the necessary electrical actuating signals by the intermediary of the electronic valve control circuitry 24 and in a manner matching the external control means in order to cause the fluid actuation of the piston 13 in the desired fashion. In this respect there may be a provision such that the electronic valve control circuitry 24 generates the switching signals for the control valve means 25 on the basis of a received switching signal or bus signal. In this respect the microprocessor necessary for the bus protocol may be employed, using suitable logic gates, for presetting the switching states of the control valve means. If in the control valve means 25 types of valves are utilized requiring a voltage differing from the normally supplied voltage—for example in the case of so-called microvalves or piezoelectric valve—it is possible for the electronic valve control circuitry 24 also to comprise the respective means for voltage conversion.

It will be clear that the electronic valve control circuitry 24 may possess its own, preferably adjustably programmable, control program, something which however is not absolutely necessary. The control signal may be supplied simply by the external control means, the electronic valve control circuitry 24 possessing suitable communication means in order to be able to distribute the incoming and possibly also outgoing control signals in accordance with correct association.

In the embodiment the control valve means 25 is divided up into two control valve units 38a and 38b, which each respectively have the functionality of a 3/2 switching valve. In this case it may be simply a question of 3/2 switching valves as such or however for example of two linked 2/2 valves, if necessary with the addition of an amplifier, something which is more particularly an advantage, if the control valve units 38a and 38b are composed of so-called microvalves. Microvalves are as a rule produced using suitable micromachining methods and render possible extremely small overall sizes, something which moreover applies for piezoelectric valve as well.

The two control valve units 38a and 38b are accommodated in the valve receiving space 26 in sequence one after the other in the longitudinal direction 4 of the slab housing 2. Owing to their short overall length they are separated axially by an intermediate space from one another. It is convenient for the control valve units 38a and 38b to be seated in the front and, respectively, rear terminal section of the valve receiving space 26, into which they are inserted from the terminal side. For fixation there may be a provision such that each control valve unit 38a and 38b is secured on the front and, respectively, rear associated covering 6a and 6b, it being possible to employ a suitable transverse outline of the valve receiving space 26 to obtain a transverse support in the interior of the slab housing 2.

For simplification of the electrical contact system and also to customize valve circuits in case of need in addition, each control valve unit 38a and 38b is provided with a printed circuit board 42a and 42b having electrical wiring and/or electrical or, respectively, electronic components, which flanks the respective control valve unit 38a and 38b on the longitudinal side associated with the electronic circuitry receiving space 23 and is in electrical contact with the respectively associated control valve unit. These printed circuit boards 42a and 42b, whose length is approximately preferably the same as that of the associated control valve unit 38a and 38b, preferably extend in parallelism to the electronic circuitry support 35 and accordingly also extend at a right angle to the longitudinal axis 3 of the cross section. The printed circuit board 42b mounted on the rear control valve unit 38b is connected by electrical contact means 43 directly with the directly adjacent electronic valve control circuitry 24. The front printed circuit board 42a associated with the front control valve unit 38a is also linked by way of second electrical conductors 14 with the electronic valve control circuitry 24.

For simplification of the assembly and any necessary electrical linking of the control valve means 25 and the electronic valve control circuitry 24 in the working example the valve receiving space 26 and the electronic circuitry receiving space 23 are designed in the form of space sections of a common receiving space merging into each other, such common receiving space being termed the control receiving space 45, the space being illustrated in FIG. 3 particularly clearly. In other words it is a question of a control receiving space 45 which is somewhat enlarged cross section, which as a single structural unit represents both the valve receiving space 26 and also the electronic circuitry receiving space 23.

In the working embodiment illustrated the position detecting means 32 accommodated in the sensor means receiving space 27 possesses a printed circuit board 45 extending for the entire length of the sensor means receiving space, such printed circuit board 45 having at least one sensor 46, represented in figure in chained lines in FIG. 1, in such a manner that it is connected with first signal conductors 47 of the printed circuit board 45.

Here the sensor 46 is preferably held on a carriage body 48, which completely or partially straddles the printed circuit board 45 in such a manner that it is held on the printed circuit board 45 and simultaneously it is guided in the longitudinal direction of the printed circuit board 45 and accordingly parallel to the longitudinal axis 4 of the housing. Guiding of the slab housing 2 is unnecessary for this reason. The electrical contact between the sensor 46 and the first signal conductors 47 is so provided that same is independent of the instantaneous of the carriage body 48 and of the sensor 46 arranged thereon.

An actuating element 49, which is ganged for movement with the piston 13 or with the piston rod 16, and for example in the form of a permanent magnet, is in a position of tripping the sensor 46—for instance in the form of a reed switch—when as part of the movement of the piston it arrives in a position radially opposite to the sensor 46. The magnetic field of the actuating element 49 may then penetrate the thin partition 52 of the slab housing 2 separating the piston receiving space 12 from the sensor means receiving space 27. When the sensor is tripped, the resulting position detection signals are transmitted by way of first signal conductors 47 to the electronic valve control circuitry 24. This takes place by way of intermediately placed third electrical conductors 53, which are provided on a rear printed circuit board 54b and are arranged axially between the rear terminal side of the principal housing body 5 and the rear covering 6b placed thereon. Pairs of electrical contact means 55, which cooperate with each other and are preferably in the form of plug connectors in this case serve to provide electrical contact of the rear printed circuit board 54b with on the one hand the printed circuit board 45 of the position detecting means 32 and on the other hand the electronic valve control circuitry 24 or with the printed circuit board 42b, coupled with it electrically, of the rear control valve unit 38b.

It will be clear that in lieu of having merely one sensor 46 a plurality of sensors could be provided able to be set in position by the user of the equipment as desired in the longitudinal direction on the printed circuit board 45, such sensors being connected with the electronic valve control circuitry 24 in a comparable manner.

By the intermediary of the carriage body 48 a satisfactory guidance of the parts may be ensured without having to insist on particularly small tolerances.

The longitudinal setting of the sensor 46 or, respectively, the carriage body 48 carrying same, is preferably performed from the outside through a longitudinal slot 56, which runs parallel to the sensor means receiving space 27 and radially extends through that housing wall section 57, which delimits the sensor means receiving space 27 on the longitudinal side opposite to the piston receiving space 12. The longitudinal slot 56 accordingly opens internally into the sensor means receiving space 27 and externally at the first outer side section 31 on the narrow side. Access to the carriage body 48 and, respectively, the sensor 46 is possible through the section 31 for the purpose of axially setting the position.

In order to prevent entry of moisture and/or other foreign matter in the sensor means receiving space 27 the longitudinal slot 56 is normally closed by a slot cover 58. In the working embodiment illustrated this cover is releasably inserted in the longitudinal slot 56 and may be removed temporarily for setting the position of the sensor 46. Preferably the slot cover 58 is constituted by an elastomeric part, which may be adapted to the desired length of the slot without any trouble.

A particular advantage of the linear drive 1 in accordance with the example is that the position detecting means 32 has a multiple function and is also employed to transmit valve control signals from the electronic valve control circuitry 42 to the front control unit 38a arranged on the front covering 6a. For this purpose second signal conductors 59 provided on the printed circuit board 45 of the position detecting means 32 as components of the above mentioned second electrical conductors 44 are employed in order to produce the electrical connection. Specifically this means in the case of the working example that as well between the front terminal side of the principal housing body 5 and the front covering 6a, placed in front of same, a printed circuit board, termed the front printed circuit board 54a, is placed in between, which like the rear printed circuit board 54b produces an electrical connection between the front control valve unit 28a and the printed circuit board 45 of the position detecting means 32. By way of the above mentioned third electrical conductors 53 there is then the further signal path to the electronic valve control circuitry 24.

The front and rear printed circuit boards 54a and 54b serve simultaneously as seal supports and they are provided with seal means 63, which ensure a hermetic joint between the the principal housing body 5 and the front and rear coverings 6a and 6b thereon. In this respect the seal means 64 may at least in part be in the form of light guide means serving to ensure that the light signals produced by light producing means on the printed circuit boards 54a and 54b are transmitted to the peripheral portion of the slab housing 2 and are thus visible for an external observer. This means that any desired display of position, function and condition is possible without any trouble.

Both the front and also the rear printed circuit boards 54a and 54b may be utilized, if required, for the integration of further electronic components, for example for valve control or for sensor systems.

In order to make the electrical and fluid power connection necessary for operation in a simple manner, in the working embodiment illustrated there is a provision such that on a common terminal face of the slab housing 2, in the present case on the rearwardly facing terminal face of the rear covering 6b, in addition to the electrical connection means 34 furthermore fluid power connection means 64 are present for the supply and/or output of fluid energy. The fluid connection means 64 communicate with fluid ducts 65 running in the interior of the slab housing 2, which lead to the two control valve units 38a and 38b in order to supply compressed air or to vent it. By means of the control valve units 38a and 38b the further fluid ducts 65 are linked with the above mentioned first fluid ducts 17a and 17b in a manner dependent on the position of switching in order to cause the desired piston movement.

1. A fluid power linear drive comprising a slab housing (2) with an elongated cross sectional outline, in which flat housing a plurality of receiving spaces (8) are located placed in a common housing plane adjacent to each other in the direction of the cross section's longitudinal axis (3), a piston receiving space being provided at a first one of the two narrow sides (21) of the housing, such piston receiving space extending in the longitudinal direction and containing a piston (13) connected with an outwardly extending force output part (16) while at the opposite second narrow housing side (22) an electronic circuitry receiving space (23) is provided, which contains electronic valve control circuitry (24), and between the piston receiving space (12) and the electronic circuitry receiving space (23) at least one valve receiving space (26) for electrically operated control valve means (25) is located, such control valve means serving for the control of the fluid actuation of the piston (13).

2. The linear drive as set forth in claim 1, characterized in that the electronic valve control circuitry (24) is provided on a board-like electronic circuitry support (35) preferably constituted by a printed circuit board.

3. The linear drive as set forth in claim 2, characterized in that the board-like electronic circuitry support (35) is so arranged that the plane of its board extends at a right angle to the cross sectional longitudinal axis (3) of the slab housing (2).

4. The linear drive as set forth in any one of the claims 1 through 3, characterized in that on the side facing the electronic circuitry receiving space (23) the control valve means (25) contains at least one printed circuit board (42a and 42b) having electrical conductors and/or components, such printed circuit board (42a and 42b) being connected electrically with the electronic valve control circuitry (24).

5. The linear drive as set forth in claim 4, characterized in that the printed circuit board (42a and 42b) of the control valve means (25) is so arranged that the plane of its board extends at a right angle to the cross sectional longitudinal axis (3) of the slab housing (2).

6. The linear drive as set forth in any one of the claims 1 through 5, characterized in that the valve receiving space (26) and the electronic circuitry receiving space (23) are formed by merging sections of a control means receiving space (41).

7. The linear drive as set forth in any one of the claims 1 through 6, characterized in that a sensor means receiving space (27) is provided on the longitudinal side, which is opposite to the valve receiving space (26), of the piston receiving space (12) in the interior of the slab housing (2), such sensor means receiving space (27) extending along the piston receiving space (12) and containing a position detecting means (32) for the detection of the piston position.

8. The linear drive as set forth in claim 7, characterized in that the position detecting means (32) contains one or more sensors (46) able to be set in position in the longitudinal direction of the sensor means receiving space (27), such sensor means preferably being connected electrically with the electronic valve control circuitry (24).

9. The linear drive as set forth in claim 7 or claim 8, characterized in that the position detecting means (32) comprises a printed circuit board (45) running in the length direction of the sensor means receiving space (27), such printed circuit board (45) serving for the transmission of signals from the position detecting means.

10. The linear drive as set forth in claim 9 in conjunction with claim 8, characterized in that at least one sensor (46) is mounted on the printed circuit board (45) in a manner allowing longitudinal adjustment and independent of its instantaneous position is connected with the signal conductors (47) of the printed circuit board (45).

11. The linear drive as set forth in any one of the claims 1 through 10, characterized in that the control valve means (25) possesses two control valve units (38a and 38b) arranged in sequence in the longitudinal direction of the slab housing (2) and preferably having a 3/2 switching function.

12. The linear drive as set forth in claim 11 in conjunction with any one of the claims 7 through 10, characterized in that the two control valve units (38a and 38b) are arranged on opposite axial terminal portions of the slab housing (2), the electrical valve control signals being transmitted from the valve control electronic circuitry (24) by way of the position detecting means (32) to at least one of the valve units (38a).

13. The linear drive as set forth in claim 12, characterized by both a transmission of position detection signals and also a conduction of valve control signals take place by way of the printed circuit board (45) of the position detecting means (32).

14. The linear drive as set forth in any one of the claims 1 through 13, characterized in that the receiving spaces (8) are formed in a principal body (5) of the slab housing (2) and extend through the same in the longitudinal direction respectively, a covering (6a and 6b) being mounted on both terminal sides of the principal housing body (5).

15. The linear drive as set forth in claim 14, characterized in that between at least one covering (6a and 6b) and the principal housing body (5) a printed circuit board (54a and 54b), preferably provided with sealing means (63), is placed intermediately, such printed circuit board (54a and 54b) serving preferably for the transmission of valve control signals and/or position detection signals.

16. The linear drive as set forth in claim 15, characterized in that the seal means (63) are at least partly constituted by light guide means for light signals, which are more especially produced by the intermediary of the electronic valve control circuitry (24).

17. The linear drive as set forth in any one of the claims 1 through 16, characterized in that the control valve means (25) is in the form of by microvalves produced by micromachining and/or piezoelectric valves.

18. The linear drive as set forth in any one of the claims 1 through 17, characterized in that the force output part is a piston rod (16) extending to the outside at one terminal side of the slab housing (2) at least.

19. The linear drive as set forth in any one of the claims 1 through 18, characterized in that both electrical and also fluid connection means (34 and 64) are provided for electrical and fluid energy transmission on a common terminal side of the slab housing (2).
